(19) United States
(12) Patent Application Publication
(10) Pub. No.: US 2026/0301605 A1
(43) Pub. Date: Oct. 1, 2026

(54) SURGICAL SIMULATION DEVICE, SURGICAL SIMULATION LEARNING SYSTEM, CARTRIDGE FOR A SURGICAL SIMULATION DEVICE, AND METHOD FOR PRODUCING SAID CARTRIDGE

(71) Applicant: UPSURGEON S.R.L., Assago (Milano) (IT)

(72) Inventor: Federico NICOLOSI, Assago (Milano) (IT)

(21) Appl. No.: 18/880,316

(22) PCT Filed: Jun. 26, 2023
(86) PCT No.: PCT/IB2023/056561

§ 371 Date: Dec. 31, 2024

(30) Foreign Application Priority Data
Jul. 1, 2022 (IT) 102022000013993

(51) Int. Cl. G09B 23/30

(52) U.S. Cl. CPC G09B 23/303

(57) ABSTRACT

A surgical simulation device has a three-dimensional physical reproduction suitable for simulating at least partially an anatomical part of a human body, and a cartridge having a first chamber and a second chamber. The cartridge has a simulation material contained in the second chamber and suitable for simulating an internal tissue of the human body. The first chamber is suitable for containing a simulation fluid suitable for simulating a body fluid. The first chamber is in fluid communication with the second chamber by one or more fluid communication openings. A learning system including the surgical simulation device, a cartridge for the surgical simulation device, and a method for producing the cartridge are provided.

### FIELD OF APPLICATION

The present invention generally relates to the field of simulating human surgical anatomy for the purposes, for example, of anatomical and surgical teaching.

The anatomy of the human body, and in particular the anatomy of the skull and brain, and more generally that of the central nervous system, shows a high degree of complexity. As regards the nervous system and more in particular the skull and the structures contained therein, in fact, the complexity is high, due to the intricate spatial relationships and the micro-surgical perspectives.

Since it is not always possible to have access to direct experience in the operating room, understanding and learning the three-dimensional morphology of the skull and current operating techniques require in-depth study and need repeated practical exercises. Such exercises are all the more effective the more faithful to reality the anatomical models studied.

When an opening of the braincase (craniotomy) is performed for surgical intervention, the vision of the interior and thus of the brain and of the other anatomical structures is necessarily extremely limited to what is strictly necessary: it is essential to reduce the extension of the exposure area as much as possible in order to increase the patient's tolerance to the surgical treatment and to reduce the risk of complications.

Devices for simulating human surgical anatomy are known in the art, consisting of anatomical models which reproduce the skull and sometimes the structures contained therein. Such models allow the anatomy to be studied by reproducing the central nervous system generally according to anatomical views, i.e., by disassembling the parts, in other words not according to surgical views (through craniotomic approaches).

The devices on the market usually consist of a reproduction, for example, of the braincase and one or more internal structures by reproducing the interior of the head (brain, brain stem, nerves, blood vessels), with variable degrees of approximation and simplification (rigid structures, minor structures not represented or reproduced as parts of major structures, etc.).

Usually, therefore, the intracranial content is represented by a series of rigid modular elements, each of which reproduces a part of the brain.

While providing a useful aid to the basic study of the central nervous system, such a solution has some drawbacks.

The first problem is that access to the interior of the braincase of such models occurs by an opening which generally does not correspond to a neurosurgical approach, but occurs by mechanical disassembly of the model pieces, thus through a logic of anatomical, and not surgical, representation (e.g., a rough section).

A consequence of this limitation is that the student cannot appreciate the correct perspective of the various internal parts from a surgical perspective (craniotomy of a few centimeters), a perspective which may considerably vary based on the positioning of the cranial opening and the orientation in the three-dimensional space of the skull.

Other devices capable of representing greater anatomical details are often limited in the type of physical consistency of the structures themselves, as well as in the superficial aspect. Therefore, since surgical learning involves not only visual learning but also microsurgical manipulation, such rigid devices do not offer any type of tactile experience which is relevant from an educational point of view.

Furthermore, although such devices are more detailed, they are however limitedly realistic, as they are not suitable for simulating the behavior of the brain tissue being treated.

Consequently, such known devices are not effective in predicting realistic situations which occur during normal real surgical procedures.

### SOLUTION OF THE INVENTION

Therefore, there appears to be a significant need to provide a surgical simulation device of an anatomical human part, capable of overcoming the drawbacks typical of the prior art.

In particular, the object of the present invention is to provide a surgical simulation device which is as realistic as possible and capable of simulating the real behavior of human body tissues, preferably soft tissues, when subjected to surgery.

Furthermore, the object of the present invention is also to simulate as realistically as possible the bleeding reaction of a human tissue, preferably of a brain tissue, when subjected to aspiration of a portion affected by a tumor.

A further object of the present invention is to provide a surgical simulation device which is easily reusable in several different training sessions.

Furthermore, an object of the present invention is to provide a surgical simulation device which is versatile in modifying the training scenario and which does not require complicated operations for modifying the surgical training scenario or for the renewal thereof after use.

Such needs are met by a surgical simulation device, by a surgical simulation learning system, by a cartridge for a surgical simulation device, and by a method for producing said cartridge in accordance with the attached independent claims. The claims dependent thereon describe preferred or advantageous embodiments of the invention, comprising further advantageous features.

### DESCRIPTION OF THE DRAWINGS

The features and advantages of the surgical simulation device, the surgical simulation learning system, the cartridge for a surgical simulation device, and the method for producing said cartridge will become apparent from the description below of some preferred embodiments, given by way of non-limiting example, with reference to the attached figures, in which:

FIG. 1 shows a longitudinal sectional view of a surgical simulation device in an embodiment of the invention;

FIG. 2 shows a perspective view of a three-dimensional physical reproduction for a surgical simulation device according to an embodiment of the invention;

FIG. 3 shows a perspective view of a cartridge for a surgical simulation device in an embodiment of the invention, in which closing means according to an embodiment of the invention are shown;

FIG. 4 is a lateral sectional view of a surgical simulation device according to an embodiment of the present invention;

FIGS. 5a and 5b show, respectively, an exploded and an assembled elevation view of a surgical simulation device in accordance with an embodiment of the present invention;

FIGS. 6a and 6b each show a sectional view of learning system, in accordance with an embodiment of the present invention, in which a fluid capsule is represented respectively external (FIG. 6a) and in engagement with a capsule seat (FIG. 6b) obtained in the surgical simulation device;

FIG. 7 shows a perspective view of a fluid capsule in accordance with an embodiment of the present invention;

FIG. 8 shows a schematic elevation view of a fluid capsule according to an embodiment of the present invention, when inserted into a capsule seat obtained in a cartridge in accordance with an embodiment of the present invention;

FIGS. 9a and 9b show a schematic elevation view of a fluid capsule according to an embodiment of the present invention, engaged in a capsule seat in accordance with an embodiment of the present invention, in particular, respectively, in breaking configuration (9a) and in return configuration (9b);

FIG. 10 shows a perspective view of a cartridge for a surgical simulation device in accordance with an embodiment of the present invention;

FIGS. 11a and 11b respectively show a perspective view of a first cartridge portion and a second cartridge portion, suitable for forming a cartridge for a surgical simulation device in accordance with an embodiment of the present invention;

FIG. 12 shows an exploded perspective view of a learning system in accordance with an embodiment of the present invention, in which the cartridge is made according to the embodiment shown in FIG. 10;

FIGS. 13a and 13b respectively show a longitudinal sectional view and a perspective view which represent a step of a method for producing a cartridge in accordance with an embodiment of the present invention, which provides for the insertion of shutter means in fluid communication openings between a first chamber and a second chamber;

FIG. 14 shows longitudinal sectional view which represents a step of a method for producing a cartridge in accordance with an embodiment of the present invention, which provides for the removal of shutter means in fluid communication openings between the first chamber and the second chamber;

FIG. 15 shows a longitudinal sectional view of a surgical simulation learning system in an embodiment of the present invention;

FIG. 16 shows an exploded view of a surgical simulation learning system in accordance with an embodiment of the present invention;

FIG. 17 shows a perspective view, in assembly, of the learning system of FIG. 16;

FIG. 18 shows a diagram of an example of use of the learning system in an embodiment of the present invention.

### DETAILED DESCRIPTION

With reference to the aforesaid figures, a surgical simulation device 10 is collectively indicated with the reference number 10.

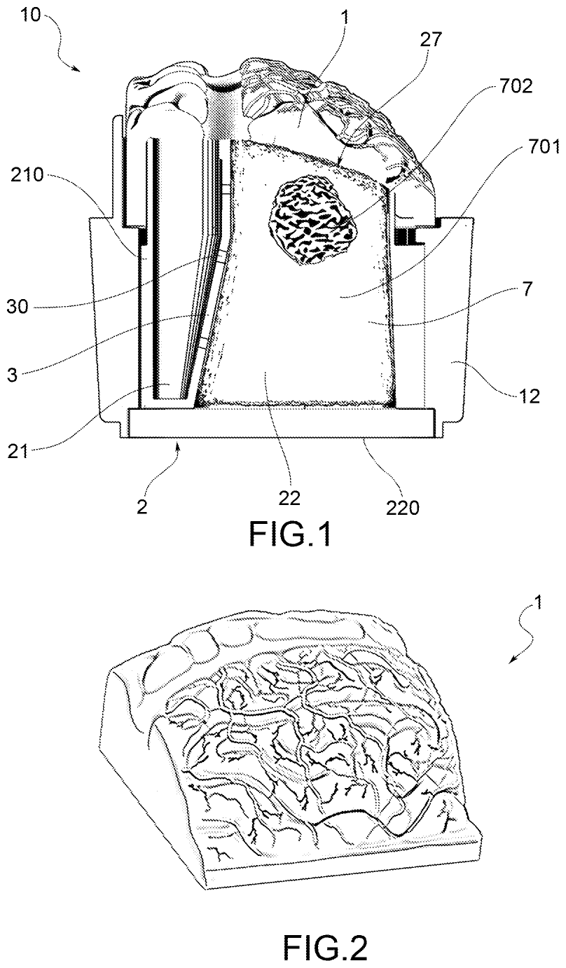

According to the present invention, and with reference, for example, to the embodiment represented in FIG. 1, the surgical simulation device 10 comprises:
a three-dimensional physical reproduction 1 suitable for simulating at least partially an anatomical part of the human body,
a cartridge 2 comprising a container 200 defining an inner compartment 20 of the cartridge 2.

In the present discussion, the term “three-dimensional physical reproduction” means a phantom, i.e., an artificial three-dimensional reconstruction, suitable for representing an anatomical part of the human body.

It is clear that the present invention, described here for the purposes of clarity for surgical simulation on an anatomical portion of a human body, is also suitable, with the appropriate modifications, for surgical simulation on an anatomical portion of an animal body, for example for veterinary surgical training.

In a preferred embodiment of the present invention, with reference to the example represented in FIG. 2, the three-dimensional physical reproduction 1 is suitable for simulating a portion of the human brain.

Furthermore, in an embodiment of the present invention, the three-dimensional physical reproduction 1 comprises a plurality of sub-reconstructions suitable for representing two or more anatomical elements.

Preferably the anatomical elements comprise one or more of the following: cerebral/cerebellar parenchyma, brain stem, cranial nerves, arterial/venous vessels, venous sinuses, meninges (dura mater, arachnoid mater, pia mater), skull, each of the sub-reconstructions is made with a material which reproduces the mechanical features of the corresponding real anatomical element.

According to an aspect of the invention, the inner compartment 20 is divided into at least a first chamber 21 and a second chamber 22.

In particular, the container 200 comprises an access zone 27 to the second chamber 22 and the three-dimensional physical reproduction 1 is placed at such an access zone 27, so that creating a passage, for example a surgical cut, in such a three-dimensional physical reproduction 1, access is allowed from the outside to said second chamber 22 through said access zone 27.

Preferably, the inner compartment 20 is defined by a base 220 and by a side wall 210.

Preferably, the access zone 27 is obtained on the side opposite the base 220, with respect to the inner compartment 20.

According to the present invention, the cartridge 2 comprises a simulation material 7 contained in the second chamber 22 and suitable for simulating an internal tissue of the human body, and the first chamber 21 is suitable for containing a simulation fluid 6 suitable for simulating a body fluid.

Preferably, the simulation material 7 is suitable for simulating a soft tissue.

The term “soft tissue” means any organic human tissue, both healthy and pathological, which has a lower density than bone tissue. For the purposes of the present invention, for example organs, portions of organs or tissues such as nervous tissue, in particular cerebral, adipose, muscular, parenchymatous, connective, cartilaginous tissue are to be understood as “soft tissues”.

In a preferred embodiment, the simulation material 7 simulates a portion of the brain affected by a neoplasm.

According to an aspect of the present invention, the first chamber 21 is in fluid communication with the second chamber 22 by one or more fluid communication openings 30 suitable for allowing the passage of fluid from said first chamber 21 to said second chamber 22.

In a preferred embodiment, with reference to the example shown in FIG. 1, the container 200 comprises a dividing wall 3 separating said first chamber 21 and said second chamber 22.

Preferably, the fluid communication openings 30 are obtained in such a dividing wall 3.

Preferably, such fluid communication openings 30 are obtained in the dividing wall 3 along superimposed levels, said superimposed levels extending on superimposed planes A, B.

Preferably, when the dividing wall 3 is substantially perpendicular to the base 220, the superimposed planes A, B are parallel to the base 220 of the container 200.

It is clear that the fluid communication openings 30 may also extend on a plurality of superimposed levels lying on a number of superimposed planes greater than two.

Preferably, each superimposed level comprises two or more fluid communication openings 30.

Even more preferably, the communication openings extend on five or more superimposed levels.

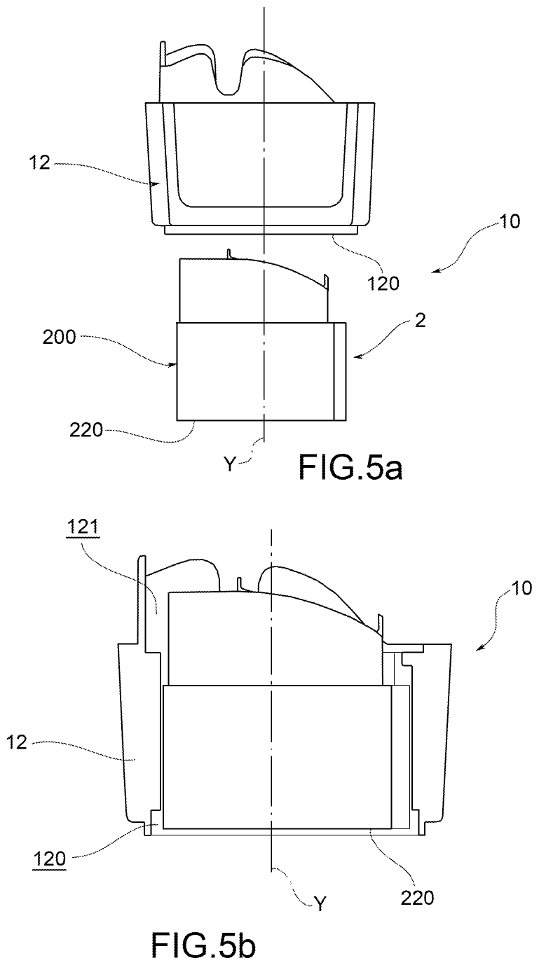

Furthermore, in an embodiment, illustrated for example in FIGS. 5a and 5b, the surgical simulation device 10 further comprises an outer frame 12 comprising a cartridge seat 120 in which the cartridge 2 is housed, and a reproduction seat 121 in which the three-dimensional physical reproduction 1 is housed.

Preferably, the cartridge 2 is housed in the cartridge seat 120 in extractable manner.

In particular, even more preferably, with reference to FIGS. 5a and 5b, the cartridge 2 is extractable from the cartridge seat 120 along an extraction direction Y perpendicular to the base 220 of the container 200.

Preferably, the cartridge 2 is extractable from the cartridge seat 120 along an extraction direction which goes from the access opening 27 to the base 220.

In an alternative embodiment, the three-dimensional physical reproduction 1 is directly engaged with the access opening 27 of the cartridge 2.

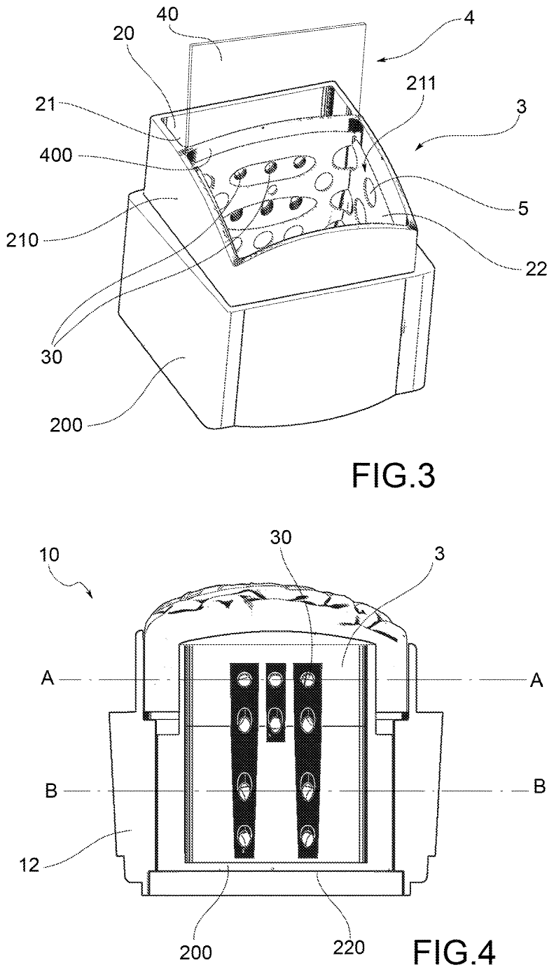

In an embodiment of the invention, with reference to the example shown in FIG. 3, the surgical simulation device 10 further comprises closing means 4 which prevent fluid communication between the first chamber 21 and the second chamber 22.

The closing means 4 are suitable for taking a first configuration in which the closing means prevent fluid communication between the first chamber 21 and the second chamber 22 and a second configuration in which fluid communication between the first chamber 21 and the second chamber 22 is allowed.

Preferably, the closing means 4 therefore allow the opening or closing of the fluid communication between the first chamber 21 and the second chamber 22 and may therefore comprise any element (removable, extractable, movable) suitable for allowing or interrupting fluid communication.

Preferably, the closing means 4 comprise a bulkhead 40 inserted into the cartridge 2 between the first chamber 21 and said one or more fluid communication openings 30, so that the passage of fluid from the first chamber 21 to the second chamber 22 is not allowed (first configuration).

In an embodiment of the invention, the bulkhead 40 is fixed, for example glued, to the dividing wall 3 and is preferably tear-off removable from such a dividing wall 3, so as to free the fluid communication between the first chamber 21 and the second chamber 22 (second configuration).

For example, the bulkhead 40 is a tear-off film applied to the dividing wall 3.

In an alternative embodiment, with reference to the example represented in FIG. 3, the cartridge 2 comprises a sliding seat 400 obtained at least partially in the container 200, in proximity to said one or more openings 30.

Such a sliding seat 400 is suitable for accommodating the bulkhead 40 and for allowing the sliding thereof to block or free the fluid communication between the first chamber 21 and the second chamber 22 through said one or more fluid communication openings 30.

According to a particularly advantageous embodiment, the container 200 comprises a side wall 210 having a side wall portion 211 facing the second chamber 22. Such a side wall portion 211 has protrusions and/or depressions 5 suitable for generating friction and acting as a support for the simulation material 7 placed in such a second chamber 22.

Preferably, in the embodiment in which the surgical simulation device 10 comprises a dividing wall 3, such protrusions and depressions 5 are also obtained on a surface of the dividing wall facing the second chamber 22.

Preferably, the simulation material 7 is a gelatinous material.

Preferably, the simulation material 7 is characterized by a hardness value according to the Shore 00 scale which is lower than 25.

Furthermore, in an advantageous embodiment of the invention, the simulation material 7 comprises a first portion 701 for simulating healthy tissue and a second portion 702 for simulating tumor tissue.

Preferably, the first portion 701 and the second portion 702 have different chemical compositions, suitable for simulating two different consistencies.

For example, preferably, the second portion 702 has a thicker consistency with respect to the first portion 701.

Preferably, both the first portion 701 and the second portion 702 are suitable for being aspirated by means of the prior art surgical aspiration instruments used to operate on a real patient.

Advantageously, this allows the student training by means of the surgical simulation device according to the present invention to use the tools he/she will have to use to perform real operations on human patients, and to acquire familiarity with the real advanced surgical instrumentation.

Furthermore, according to another advantageous aspect, this further allows the use of the device for surgical simulation according to the present invention also for demonstrations of the operation of surgical instruments, for example for advertising or research purposes, or for tests.

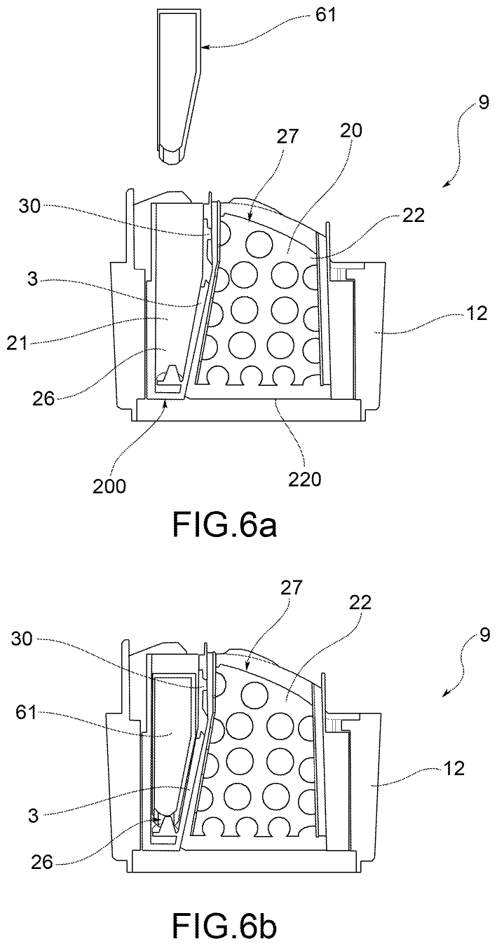

In a particularly advantageous embodiment, for example with reference to FIGS. 6a and 6b, a capsule seat 26 is obtained in the first chamber 21, which is suitable for housing a fluid capsule 61 containing a simulation fluid 6.

Preferably, in such a capsule seat 26, the cartridge 2 comprises opening means 80 suitable for causing the opening of such a fluid capsule 61 when this is engaged in the capsule seat 26.

In accordance with a variant embodiment, the opening means 80 are arranged or housed in the fluid capsule 61 and are activatable when the fluid capsule 61 is inserted into the capsule seat 26, for example by means of relative engagement between the opening means 80 and a portion of the capsule seat 26.

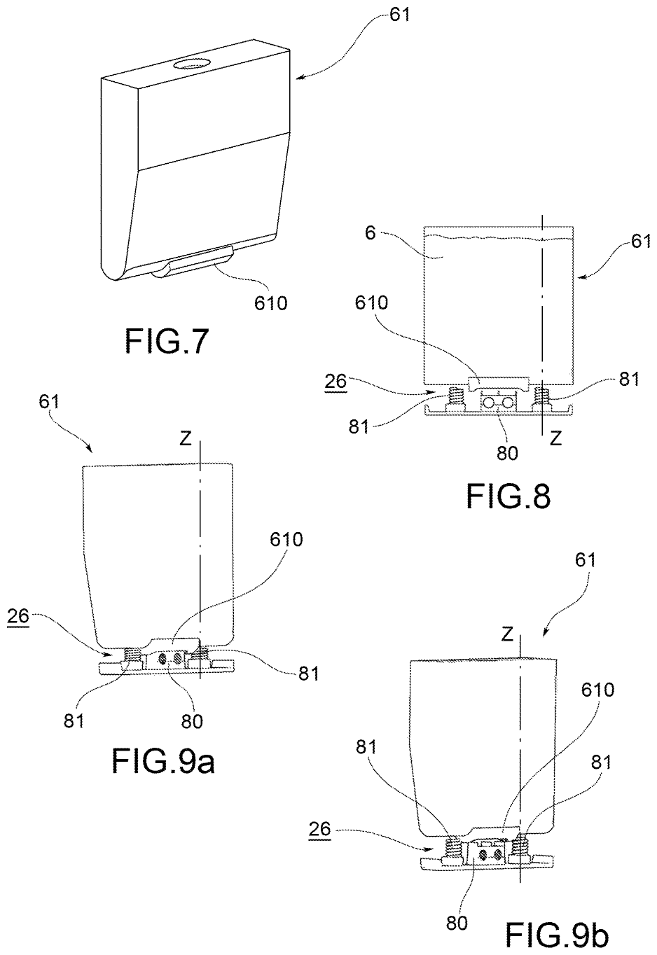

In an advantageous embodiment, for example represented in FIG. 7, the fluid capsule 61 has a breakable portion 610, for example a weakened portion, suitable for being violated (broken, lacerated, punctured, torn, changed in its permeability) by such opening means when the fluid capsule 61 is engaged in the capsule seat 26 in a breaking configuration, for example shown in FIG. 9a. In other words, in such an embodiment, the opening means 80 are suitable for causing the opening of the fluid capsule 61 by violating such a breakable portion 610.

Preferably, the opening means 80 comprise at least one tip or one protrusion suitable for tearing the breakable portion 610.

In alternative embodiments (not shown in the attached figures) the opening means 80 are therefore suitable for causing the opening of the fluid capsule 61 also by means of alternative opening mechanisms, for example they are suitable for causing the detachment of a closing portion of the capsule (for example a film placed on its bottom at a dispensing hole).

Preferably, moreover, the cartridge 2 comprises, in the capsule seat 26, return means 81 suitable for allowing a relative movement between the fluid capsule 61 and the capsule seat 26.

Preferably, following the opening of the fluid capsule 61 by said opening means 80, the return means 81 are suitable for pushing the fluid capsule 61 along a return direction Z, preferably perpendicular to the base 220, so as to cause the simulation fluid 6 to escape and to allow the simulation fluid 6 to reach the one or more fluid communication openings 30.

In other words, the return means 81 are suitable for bringing the fluid capsule 61 from the breaking configuration to a return configuration, for example represented in FIG. 9b.

Preferably, the return means 81 are suitable for pushing the fluid capsule along the return direction Z and for allowing the creation of a gap between the fluid capsule 61 and the capsule seat 26, at the fluid communication openings 30, so that the simulation fluid 6 penetrates in such a gap and reaches the second chamber 22 by passing in said fluid communication openings 30.

Preferably, the return means 81 are two elastic elements, for example springs, placed in the capsule seat 26 close to the opening means 80.

Preferably, the opening means 80 are interposed between the return means 81.

For example, in the embodiment in which the opening means 80 comprise a tip, and the return means 81 are two springs, the tip is interposed in the capsule seat between the two springs.

Preferably, the capsule seat 26 comprises a bottom, at the base 220 and the opening means 80 and the return means 81 are placed on the bottom of the capsule seat 26.

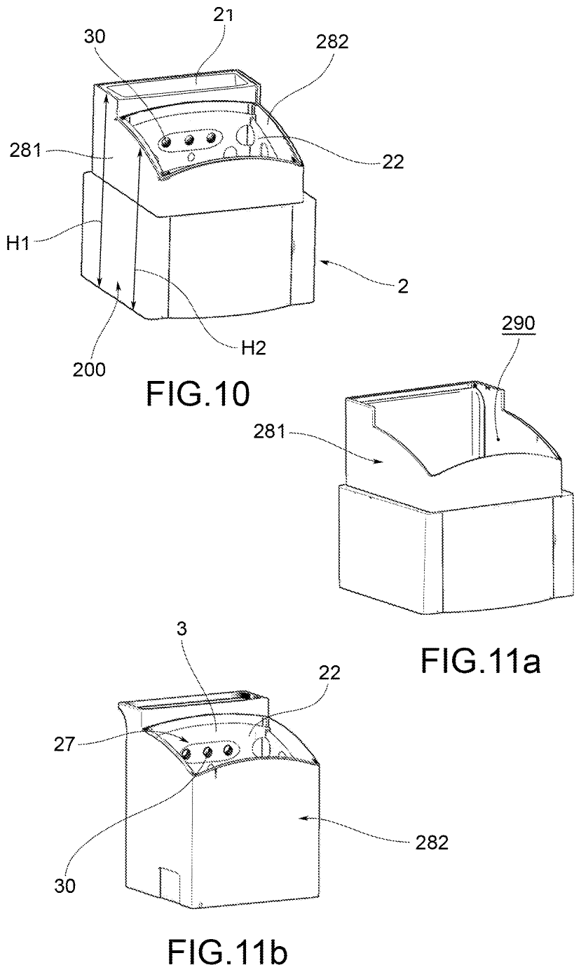

According to an advantageous variant of the present invention, with reference to the embodiment of FIG. 10 and FIGS. 11a and 11b, the container 200 is formed by a first cartridge portion 281 and a second cartridge portion 282. This allows for a simpler construction of the device. Furthermore, this may also allow a further greater versatility of change of scenario, as well as a possible maintenance of the same fluid or of the same fluid capsule in the change of scenario.

Preferably, the first cartridge portion 281 and the second cartridge portion 282 are assembled together to form the container 200.

Preferably, according to such an embodiment, the first chamber 21 and the second chamber 22 are formed by assembling such first 281 and second 282 cartridge portions.

In particular, the first cartridge portion 281 and the second cartridge portion 282 are distinct bodies assembled together to form the container 200, so that the first chamber 21 and the second chamber 22 are formed following the assembly of such first 281 and second 282 cartridge portions.

In particular, moreover, in an embodiment, the first cartridge portion 281 comprises an assembly seat 290 in which the second cartridge portion 282 is housed. With particular reference to FIGS. 11a, 11b, the assembly between the first cartridge portion 281 and the second cartridge portion 282 thus occurs by inserting the second cartridge portion 282 shown in FIG. 11b into the first cartridge portion 281 shown in FIG. 11a. Preferably, the first cartridge portion 281 accommodates and at least partially wraps the second cartridge portion 282.

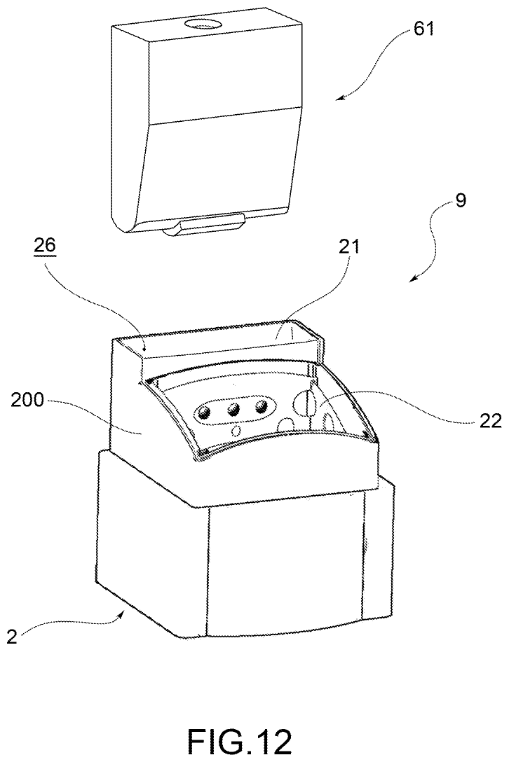

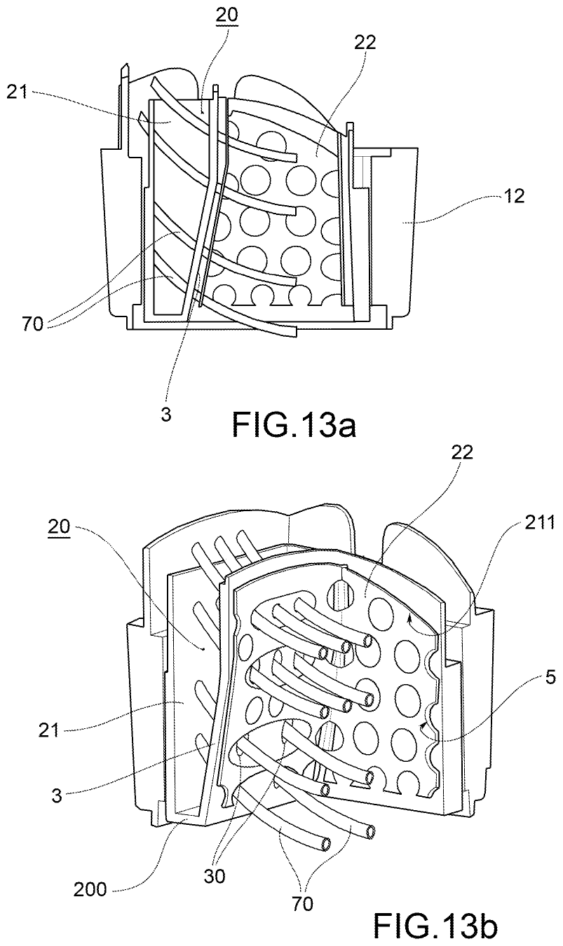

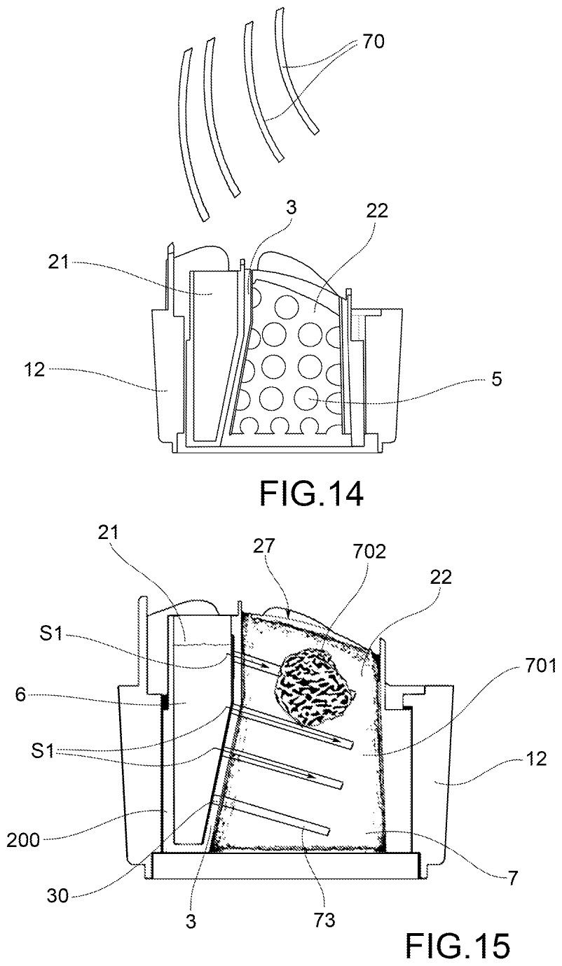

It is clear that, as illustrated in the example of FIG. 12, also a cartridge 2 according to such an embodiment is suitable for accommodating a fluid capsule 61 in a capsule seat 26 obtained in the first chamber 21, in accordance with the embodiments previously described.

Preferably, the dividing wall 3 is integrated in the second cartridge portion 282, i.e., the dividing wall 3 is part of the second cartridge portion 282.

Preferably, the dividing wall 3 is only part of the second cartridge portion 282 and not of the first cartridge portion 281.

In an alternative embodiment, the container 200 is a single piece.

Furthermore, preferably, the first chamber 21 extends from the base 220 by an average height of the first chamber H1 and the second chamber 22 extends from the base 220 by an average height of the second chamber H2 which is less than said average height of the first chamber H1.

According to an advantageous variant of the invention, with reference to the embodiment of FIG. 15, one or more fluid conduits 73 are obtained in the simulation material 7, which extend from said one or more fluid communication openings 30 into the simulation material 7 in the second chamber 22.

Such fluid conduits 73 are suitable for allowing the infiltration S1 of a simulation fluid 6 from said one or more fluid communication openings 30 into the simulation material 7.

In an advantageous embodiment of the present invention, such fluid conduits 73 are obtained by means of the method for producing a cartridge according to the present invention and described in detail below.

The object of the present invention is further a surgical simulation learning system 9 comprising a surgical simulation device 10 according to the present invention and a simulation fluid 6 suitable for simulating a body fluid, preferably fake blood, housed in the first chamber 21 of the cartridge 2 of said surgical simulation device 10.

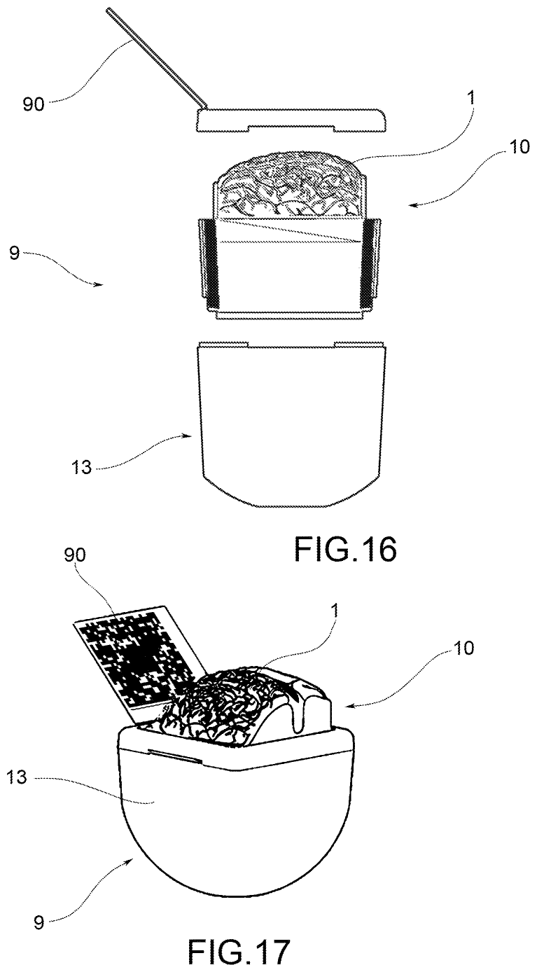

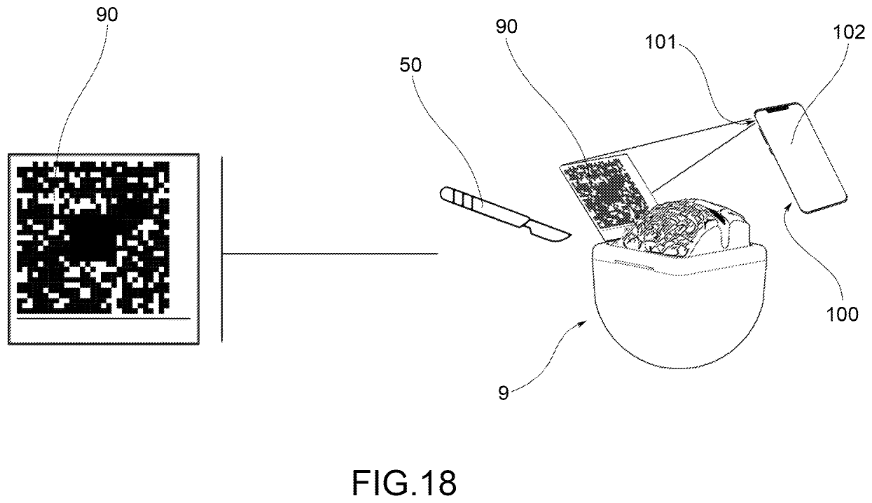

Examples of embodiments of a learning system according to the present invention are represented in FIGS. 6a, 6b, 12, 15, 16 and 17.

It should be clarified that in some attached figures, for ease of view and to make the invention intelligible to those skilled in the art, the simulation material 7 or the simulation fluid 6, or some walls of the container 200 have not been represented, to allow the internal view of the chambers 21 and 22.

However, it is clear that a surgical simulation device 10 according to the present invention comprises a simulation material 7 in the second chamber 22 and that a surgical simulation learning system according to the present invention comprises such a surgical simulation device 10 and a simulation fluid 6 in the first chamber 21.

In an embodiment, for example with reference to FIG. 15, the simulation fluid 6 is directly housed in the first chamber 21, i.e., the simulation fluid 6 contained in the first chamber 21 is at least partially directly in contact with the container 200.

Preferably, in such an embodiment, the simulation fluid 6 is entirely in contact with the container 200, i.e., there are no further elements interposed between the simulation fluid 6 and the container 200.

According to an embodiment of the invention, a capsule seat 26 is obtained in the first chamber 21 and said one or more openings 30 are obtained in at least one portion of said capsule seat 26.

According to such an embodiment, the simulation fluid 6 is at least partially housed in a fluid capsule 61 housed in said capsule seat 26.

It is clear that all the embodiments previously described with regard to the capsule seat 26 and the fluid capsule 61 for the surgical simulation device 10 apply to the present embodiment.

Preferably, the learning system 9 comprises a support movable in the three dimensions 13 for positioning and orienting the surgical simulation device 10 in three-dimensional space.

Preferably, the movable support 13 comprises a device seat which houses the surgical simulation device 10 in an oriented manner.

Furthermore, preferably, the learning system 9 comprises a two-dimensional code 90, preferably a quick response (or QR) code.

Such a two-dimensional code 90 is configured to be acquired by an image acquisition system 101 of an electronic support 100, for example by a camera 101 of a smartphone 100, and to activate a processing system of said electronic support 100, so as to generate an augmented reality view and represent it on a display system 102, for example on a smartphone screen, when the image acquisition system 101 acquires the two-dimensional code 90 upon operator command.

Thereby, advantageously, the operator using the learning system 9 according to the present embodiment may apply augmented reality to the learning system 9 and operate even more effectively on the learning system 9 by means of a surgical instrument 50, using the realistic augmented reality view provided by the display system 102.

It is clear that a cartridge 2 for a surgical simulation device 10 also forms the object of the present invention, per se.

The cartridge 2 according to the present invention comprises a container 200 defining an inner compartment 20 of the cartridge 2, said inner compartment 20 being divided into at least a first chamber 21 and a second chamber 22.

The cartridge 2 comprises a simulation material 7 contained in the second chamber 22 and suitable for representing an internal tissue of the human body, preferably a soft tissue, and the first chamber 21 is suitable for containing a simulation fluid 6 suitable for simulating a body fluid.

According to the invention, the first chamber 21 and the second chamber 22 are in fluid communication by means of one or more fluid communication openings 30, suitable for allowing the passage of fluid from said first chamber 21 to said second chamber 22.

Preferably, one or more fluid conduits 73 are obtained in the simulation material 7, which extend from said one or more fluid communication openings 30 into the simulation material 7 in the second chamber 22.

Such fluid conduits 73 are suitable for allowing the infiltration S1 of a simulation fluid 6 from said one or more fluid communication openings 30 into the simulation material 7.

An object of the present invention is further a method for producing a cartridge 2 for a surgical simulation device 10 in accordance with the present invention, comprising, in order, the following steps:
a) providing a container 200 defining an inner compartment 20 divided into a first chamber 21 and a second chamber 22, said first and second chambers 21, 22 being in fluid communication with each other by means of one or more fluid communication openings 30;
b) providing one or more shutter means 70, preferably one or more wires 70, suitable for being inserted into said one or more fluid communication openings 30 and for extending into the second chamber 22;
c) inserting said one or more shutter means 70 into said one or more fluid communication openings 30, so that said one or more shutter means 70 close said one or more fluid communication openings 30 and occupy part of the second chamber 22;
d) casting the simulation material 7 into the second chamber 22, so that said simulation material 7 occupies the volume of the second chamber 22 not occupied by said one or more shutter means 70;
e) waiting for the cooling of said simulation material 7 in the second chamber 22, until such simulation material 7 thickens and sets completely;
f) removing said one or more shutter means 70 by sliding them through said one or more fluid communication openings 30, so that one or more fluid conduits 73 are formed, extending from the one or more fluid communication openings 30 into the simulation material 7, said fluid conduits 73 being suitable for allowing the infiltration of a simulation fluid 6 from the first chamber 21 into the simulation material 7.

Preferably, when the container 200 is formed by a first cartridge portion 281 and a second cartridge portion 282, step a) of the method is replaced by a step a′) of providing a second cartridge portion 282 in which fluid communication openings 30 are obtained.

That is, in the embodiment in which the container 200 comprises two cartridge portions 281 and 282, the method according to the present invention may be actuated only on the second cartridge portion 282.

Advantageously, this allows greater freedom of movement for the producer in inserting and/or removing the shutter means 70 from the fluid communication openings 30, since there is no space constraint generated by the walls of the first chamber 281.

Furthermore, according to such an embodiment, the method also provides a final step g) of assembling the second cartridge portion 282 with the first cartridge portion 281 to obtain the container 200.

Innovatively, the present invention solves the typical drawbacks of simulation devices of the prior art.

Advantageously, the present invention lends itself to being applied to a large number of different anatomical districts, i.e., it is suitable for allowing the simulation of surgery in anatomical districts located in the most diverse parts of the human body.

Advantageously, in particular, the present invention is suitable for effectively and realistically simulating neurosurgical operations, especially operations for the removal of tumor matter in the brain.

According to a further advantage, the surgical simulation device allows the interchangeability of the cartridge in different frames, and at the same time the combination of the cartridge with different three-dimensional physical reproductions, thus allowing the easy re-use in several different training sessions and the versatility in modifying the surgical scenario to be simulated.

According to an even further advantage, the surgical simulation device according to the present invention allows the infiltration of a simulation fluid, for example fake blood, into the second chamber, i.e., in the simulation material, favoring the realism of the infiltration of liquids in (or, more specifically, bleeding of) tissue during surgery.

According to a further advantage, the surgical simulation device according to the invention allows using the surgical instrumentation which is used during operations on real patients in the operating room, consequently, it allows the surgeon training by carrying out the simulation to also familiarize himself with the instrumentation.

Advantageously, furthermore, the cartridge and the other components of the surgical simulation device are scalable according to learning requirements.

Advantageously, moreover, the method for producing a cartridge according to the present invention allows infiltration conduits into the simulation material to be rapidly obtained, such conduits further facilitating the passage of fluid in the simulation material and once again favoring a more realistic simulation.

Advantageously, moreover, the use of a fluid capsule which is separate from the cartridge for the transport of the simulation fluid allows the undesired infiltration of the simulation fluid during the steps preceding its use to be avoided, i.e., it favors the transport of the simulation device ensuring the integrity of the product until delivery to the user.

According to a further advantage, the embodiment which provides for the presence of closing means, for example a bulkhead, allows the transport of a simulation learning system simultaneously containing the simulation material in the second chamber and the simulation fluid in the first chamber, keeping the chambers fluidly separated until the user removes such means. Therefore, in such an embodiment, advantageously, the transport of the learning system is allowed even when the simulation fluid is directly introduced into the second chamber, i.e., when it is directly in contact with at least one wall of the first chamber.

It is clear that, to the embodiments of the aforesaid invention, a person skilled in the art, in order to meet specific needs, could make variations or substitutions of elements with functionally equivalent ones. These variants are also contained within the scope of protection as defined by the following claims. Moreover, each variant described as belonging to a possible embodiment may be implemented independently of the other variants described.

1. A surgical simulation device comprising:
a three-dimensional physical reproduction suitable for simulating at least partially an anatomical part of a human body, and
a cartridge comprising a container defining an inner compartment of the cartridge, said inner compartment being divided into at least a first chamber and a second chamber,
wherein said container comprises an access zone to the second chamber and wherein the three-dimensional physical reproduction is placed at said access zone, so that creating a passage, optionally the passage being a surgical cut, in the three-dimensional physical reproduction, access is allowed from an outside to said second chamber through said access zone,
wherein said cartridge further comprises a simulation material contained in said second chamber and suitable for simulating an internal tissue of the human body,
wherein said first chamber is suitable for containing a simulation fluid suitable for simulating a body fluid, and
wherein the first chamber is in fluid communication with the second chamber by one or more fluid communication openings suitable for allowing a passage of fluid from said first chamber to said second chamber.

2. The surgical simulation device of claim 1, wherein the container further comprises a dividing wall separating said first chamber and said second chamber, and wherein said one or more fluid communication openings are obtained in said dividing wall.

3. The surgical simulation device of claim 2, wherein said one or more fluid communication openings are obtained in said dividing wall along superimposed levels, said superimposed levels extending on superimposed planes.

4. The surgical simulation device of claim 1, further comprising an outer frame, said outer frame comprising a cartridge seat in which the cartridge is accommodated, and a reproduction seat in which the three-dimensional physical reproduction is housed.

5. The surgical simulation device of claim 4, wherein the cartridge is accommodated in the cartridge seat in extractable manner.

6. The surgical simulation device of claim 5, wherein the container comprises a base, and wherein the cartridge is extractable from the cartridge seat along an extraction direction perpendicular to said base.

7. The surgical simulation device of claim 1, further comprising closing means suitable for taking a first configuration, in which said closing means prevent a fluid communication between the first chamber and the second chamber, and a second configuration, in which the fluid communication between the first chamber and the second chamber is allowed.

8. The surgical simulation device of claim 7, wherein the closing means comprise a bulkhead inserted into the cartridge between the first chamber and said one or more fluid communication openings, so that the passage of fluid from the first chamber to the second chamber is not allowed.

9. The surgical simulation device of claim 8, wherein the cartridge comprises a sliding seat at least partially obtained in the container, close to said one or more fluid communication openings, said sliding seat being suitable for accommodating said bulkhead and allow a sliding of the bulkhead to block or free the fluid communication between the first chamber and the second chamber through said one or more fluid communication openings.

10. The surgical simulation device of claim 1, wherein the container further comprises a side wall having a side wall portion facing the second chamber, and wherein said side wall portion has protrusions and/or depressions suitable for generating friction and acting as a support for the simulation material placed in the second chamber.

11. The surgical simulation device of claim 1, wherein the container is formed by a first cartridge portion and a second cartridge portion, wherein the first cartridge portion and the second cartridge portion are distinct bodies assembled together to form the container, so that the first chamber and the second chamber are formed upon assembling the first and second cartridge portions.

12. The surgical simulation device of claim 1, wherein a capsule seat obtained in the first chamber is suitable for housing a fluid capsule containing the simulation fluid, and wherein the cartridge further comprises opening means or the fluid capsule comprises opening means, said opening means being suitable for causing an opening of said fluid capsule when the fluid capsule is engaged in the capsule seat.

13. The surgical simulation device of claim 12, wherein the cartridge comprises, in the capsule seat, return means suitable for allowing a relative movement between the fluid capsule and the capsule seat, so that upon opening the fluid capsule by said opening means, the return means are suitable for pushing the fluid capsule along a return direction so as to cause the simulation fluid to escape and to allow the simulation fluid to reach the one or more fluid communication openings.

14. The surgical simulation device of claim 1, wherein one or more fluid conduits are formed in the simulation material, which extend from said one or more fluid communication openings into the simulation material in the second chamber, said one or more fluid conduits being suitable for allowing an infiltration of the simulation fluid from said one or more fluid communication openings into the simulation material.

15. A surgical simulation learning system comprising the surgical simulation device of claim 1, and a simulation fluid suitable for simulating a body fluid, preferably fake blood, housed in the first chamber of the cartridge of said surgical simulation device.

16. The surgical simulation learning system of claim 15, wherein the simulation fluid is directly accommodated in the first chamber, the simulation fluid contained in the first chamber being at least partially directly in contact with the container.

17. The surgical simulation learning system of claim 15, wherein a capsule seat is obtained in the first chamber, wherein said one or more fluid communication openings are obtained in at least one portion of said capsule seat, and wherein the simulation fluid is at least partially accommodated inside a fluid capsule housed in said capsule seat.

18. A cartridge comprising a container defining an inner compartment of the cartridge, said container being divided into at least a first chamber and a second chamber,
wherein said cartridge comprises a simulation material contained in said second chamber and suitable for simulating an internal tissue of a human body,
wherein said first chamber is suitable for containing a simulation fluid suitable for simulating a body fluid, and
wherein the first chamber and the second chamber are in fluid communication by one or more fluid communication openings suitable for allowing a passage of fluid from said first chamber to said second chamber.

19. The cartridge of claim 18, wherein one or more fluid conduits are formed in the simulation material, which extend from said one or more fluid communication openings into the simulation material in the second chamber, said fluid conduits being suitable for allowing an infiltration of the simulation fluid from said one or more fluid communication openings into the simulation material.

20. A method for producing a cartridge for a surgical simulation device that comprises:
a three-dimensional physical reproduction suitable for simulating at least partially an anatomical part of a human body, and
a cartridge comprising a container defining an inner compartment of the cartridge, said inner compartment being divided into at least a first chamber and a second chamber,
wherein said container comprises an access zone to the second chamber, and wherein the three-dimensional physical reproduction is placed at said access zone, so that creating a passage, optionally the passage being a surgical cut, in the three-dimensional physical reproduction, access is allowed from an outside to said second chamber through said access zone,
wherein said cartridge further comprises a simulation material contained in said second chamber and suitable for simulating an internal tissue of the human body,
wherein said first chamber is suitable for containing a simulation fluid suitable for simulating a body fluid, and
wherein the first chamber is in fluid communication with the second chamber by one or more fluid communication openings suitable for allowing a passage of fluid from said first chamber to said second chamber,
the method comprising, in order, the following steps:
a) providing a container defining an inner compartment divided into a first chamber and a second chamber, said first and second chambers being in fluid communication with each other by one or more fluid communication openings;
b) providing one or more shutter means, preferably one or more wires, suitable for being inserted into said one or more fluid communication openings and for extending into the second chamber;
c) inserting said one or more shutter means into said one or more fluid communication openings, so that said one or more shutter means close said one or more fluid communication openings and occupy part of the second chamber;
d) casting the simulation material into the second chamber, so that said simulation material occupies a volume of the second chamber not occupied by said one or more shutter means;
e) waiting for cooling of said simulation material in the second chamber, until said simulation material thickens and sets completely; and
f) removing said one or more shutter means by sliding the one or more shutter means through said one or more fluid communication openings, so that one or more fluid conduits are formed, extending from the one or more fluid communication openings into the simulation material, said one or more fluid conduits being suitable for allowing an infiltration of the simulation fluid from the first chamber into the simulation material.
